(19) United States
(12) Patent Application Publication
(10) Pub. No.: US 2016/0345091 A1
(43) Pub. Date: Nov. 24, 2016

(54) LOUDSPEAKER MADE OF PAPER MATERIAL

(71) Applicants: Fu Tai Hua Industry (Shenzhen) Co., Ltd., Shenzhen (CN); HON HAI PRECISION INDUSTRY CO., LTD., New Taipei (TW)

(72) Inventors: CHEN-CHING CHU, New Taipei (TW); CHENG-KUO LEE, New Taipei (TW); MING-KUN ZHONG, Shenzhen (CN)

(21) Appl. No.: 14/788,206

(22) Filed: Jun. 30, 2015

(30) Foreign Application Priority Data
May 19, 2015 (CN) 201510256586.2

(51) Int. Cl. H04R 1/30; H04R 1/02

(52) U.S. Cl. CPC H04R 1/30; H04R 1/026; H04R 2499/11; H04R 2420/07

(57) ABSTRACT

A loudspeaker which is capable of attaching to an accessory of an electronic device. The loudspeaker includes a first panel; a second panel; a third panel; a fourth panel; a fifth panel; a sixth panel, wherein the first panel, the second panel, the third panel, the fourth panel, the fifth panel, and the sixth panel are each made of paper material and portray graphics in virtual three-dimensional. A first horn is attached on the inner side of the first panel and a second horn is attached on the inner side of the second panel.

### CROSS-REFERENCE TO RELATED APPLICATIONS

This application claims priority to Chinese Patent Application No. 201510256586.2 filed on May 19, 2015, the contents of which are incorporated by reference herein.

### FIELD

The subject matter herein generally relates to audio production.

### BACKGROUND

A loudspeaker converts an electrical signal into an acoustic signal. A loudspeaker can include one or more speakers within a housing. A loudspeaker is typically connected to an audio source and/or amplifier which is configured to drive the loudspeaker.

### BRIEF DESCRIPTION OF THE DRAWINGS

Many aspects of the disclosure can be better understood with reference to the following drawings. The components in the drawings are not necessarily drawn to scale, the emphasis instead being placed upon clearly illustrating the principles of the disclosure. Moreover, in the drawings, like reference numerals designate corresponding parts throughout the several views.

FIG. 1 is one embodiment of an electronic device with an accessory.

FIG. 2 illustrates a diagrammatic view of an example of a loudspeaker.

FIG. 3 illustrates a diagrammatic view of another example of a loudspeaker.

FIG. 4 illustrates a diagrammatic view of an example of a loudspeaker.

FIG. 5 illustrates a front view of one example of a loudspeaker.

FIG. 6 illustrates a front view of another example of a loudspeaker.

FIG. 7 illustrates a diagrammatic view of an example of a loudspeaker.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures, and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

The present disclosure, including the accompanying drawings, is illustrated by way of example and not by way of limitation. It should be noted that references to “an” or “one” embodiment in this disclosure are not necessarily to the same embodiment, and such references mean “at least one”.

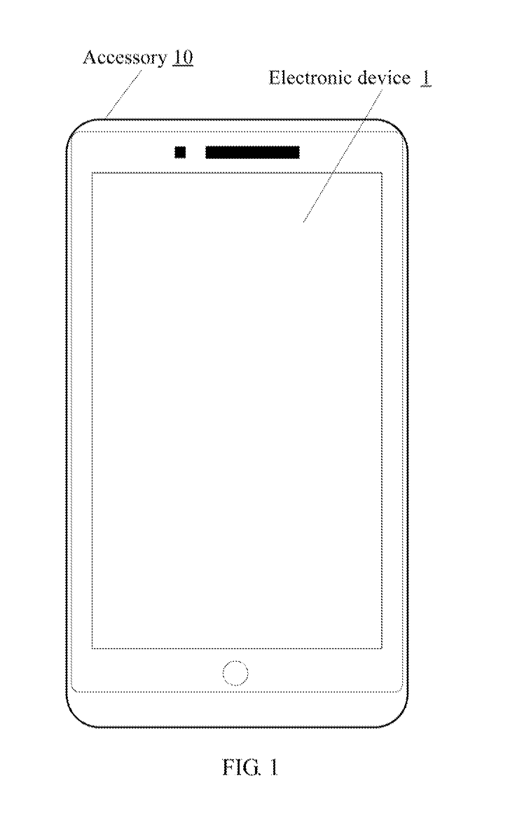

FIG. 1 illustrates one embodiment of an electronic device with an accessory. In at least one embodiment as shown in FIG. 1, an electronic device 1 can be a tablet computer, a mobile phone, a personal digital assistant (PDA), or any other electronic device. In some embodiments, there can be an accessory 10 behind the electronic device 1. The accessory 10 can be a protective cover, or a portable power source for the electronic device 1. FIG. 1 illustrates only one example of the electronic device 1, other examples can include more or fewer components than illustrated, or have a different configuration of the various components.

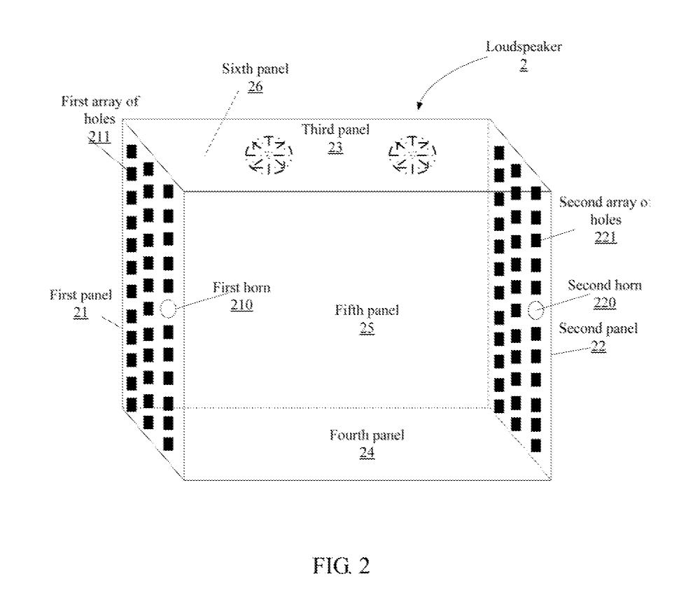

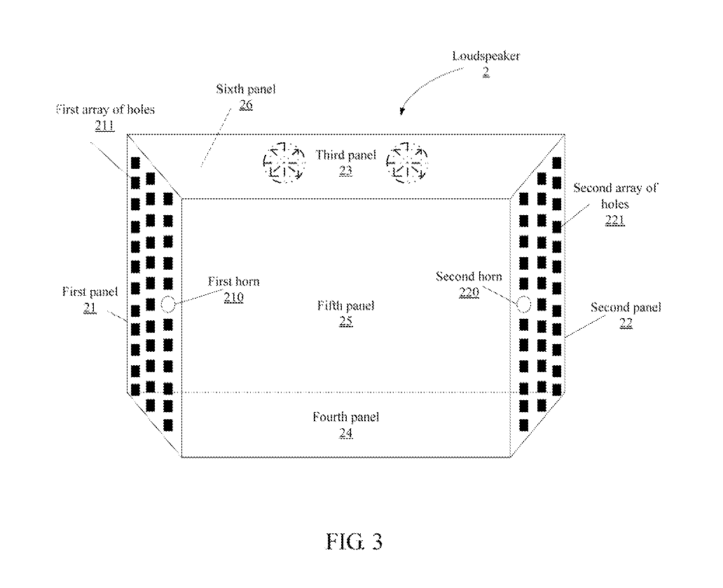

FIG. 2 illustrates a loudspeaker. In at least one embodiment as shown in FIG. 2, the loudspeaker 2 includes, but is not limited to, components such as first panel 21, a second panel 22, a third panel 23, a fourth panel 24, a fifth panel 25, and a sixth panel 26. The first panel 21, second panel 22, third panel 23, fourth panel 24, fifth panel 25, and sixth panel 26, can portray graphics in virtual three-dimensions. In some embodiments, the virtual three-dimensions graphics references to the panels 21-26 can be able to make the loudspeaker 2 looks like a three-dimension. but it is not really three-dimension. That is to say the panels 21-26 are not be seamlessly integrated with each other, the panels 21-26 are separated. When a user folds the panels 21-26 to make them together, it can be a three-dimension graphic. A shape of the loudspeaker 2 can be cuboids, or a frustum of a pyramid (as shown in FIG. 3). Sound amplification effect of frustum of a pyramid is typically better than that of the square or rectangle. In some embodiments, the panels 21-26 are made of paper material which can be folded and not easily torn or broken. For example, the paper material may be Kraft paper, rice paper, oiled cellulose paper, and or other fibrous material.

In at least one embodiment, there can be a first horn 210 attached on the inner side of the first panel 21. There can be a second horn 220 attached on the inner side of the second panel 22. A sound frequency of the first horn 210 and the second horn 220 can be range of 200-20000 hertz. In some embodiments, the first horn 210 and the second horn 220 can be symmetrical about the electronic device 1.

In at least one embodiment, there can be a first array of holes 211 distributed evenly on the surface of the first panel 21, used for releasing sound waves from the first horn 210 in the loudspeaker 2. There can be a second array of holes 221 distributed evenly on the surface of the second panel 22, used for releasing sound waves from the second horn 220 in the loudspeaker 2. In some embodiments, the first array of holes 211 distributed evenly on the surface of the first panel 21 and can provide an exit to the exterior for sound and heat from the first horn 210. The second array of holes 221 distributed evenly on the surface of the second panel 22 can provide an exit to the exterior for sound and heat from the second horn 220 In some embodiments, the paths to the exterior provided by the first and second array of holes 211 and 221 can discharge heat generated by the working of the first horn 210 and the second horn 220.

In at least one embodiment, the first panel 23 can be decorated, for example, using a circle, a star, a triangle, cartoon depictions, or other decorations. Preferably, the decoration panel can enhance appearance, and absorb a high frequency waves radiated by the first horn 210 and the second horn 220 in the loudspeaker 2.

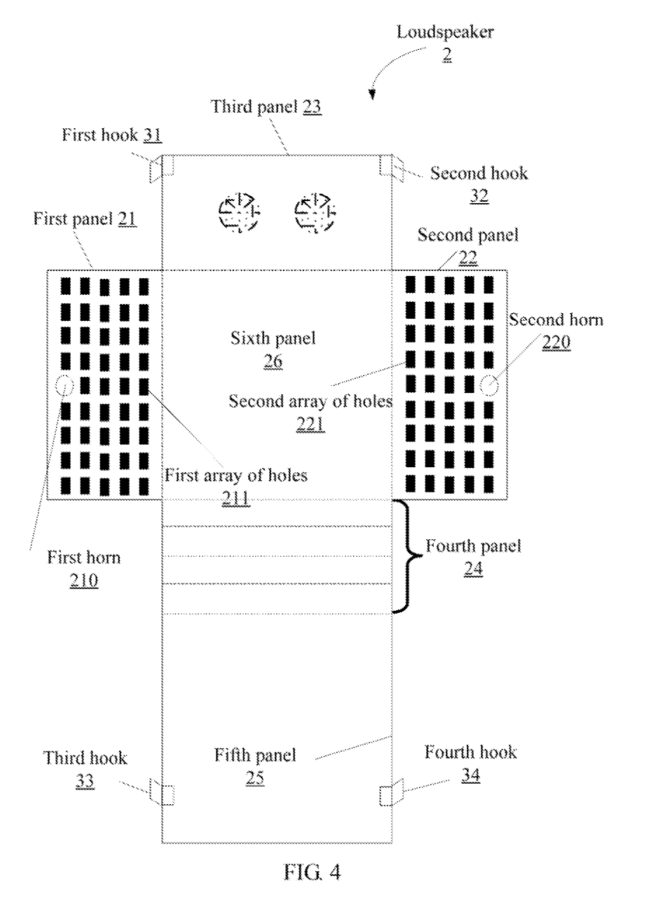

FIG. 4 illustrates a panel view of an example of a paper loudspeaker. In at least one embodiment, the sixth panel 26 can be seamlessly integrated with the first panel 21, the second panel 22, the third panel 23 and the fourth panel 24. The fourth panel 24 can be seamlessly integrated with the fifth panel 25. The first panel 21 and the second panel 22 can be removable, and connect to the third panel 23 and the fourth panel 24 respectively.

In at least one embodiment, there can be a first hook 31 fixed on an outer edge of the third panel 23. The first hook 31 can extend out of the left of the third panel 23 at approximately a right angle. When the loudspeaker 2 is folded, the first hook 31 can hook the first panel 21 to the first panel 21 and the third panel 23.

In at least one embodiment, there can be a second hook 32 fixed on another outer edge of the third panel 23. The second hook 32 can extend out of the right of the third panel 23 at approximately a right angle. When the loudspeaker 2 is folded, the second hook 32 can hook the second panel 22 to the second panel 22 and the third panel 23.

In at least one embodiment, there can be a third hook 33 fixed on an outer edge of the fifth panel 25. The third hook 33 can extend out of the left of the fifth panel 25 at approximately a right angle. When the loudspeaker 2 is folded, the third hook 33 can hook the first panel 21 to the first panel 21 and the fifth panel 25.

In at least one embodiment, there can be a fourth hook 34 fixed on another outer edge of the fifth panel 25. The fourth hook 34 can extend out of the right of the fifth panel 25 at approximately a right angle. When the loudspeaker 2 is folded, the fourth hook 34 can hook the second panel 22 to the second panel 22 and the fifth panel 25.

In at least one embodiment, there can be at least one crease on the fourth panel 24. Preferably, the at least one crease can be on the middle of the fourth panel 24. In some embodiments, there can be creases, the number of which should be odd. Folding the fourth panel 24 along with the creases can make the fifth panel 25 and the sixth panel 26 overlap together, and the fourth panel 24 will be between the fifth panel 25 and the sixth panel 26.

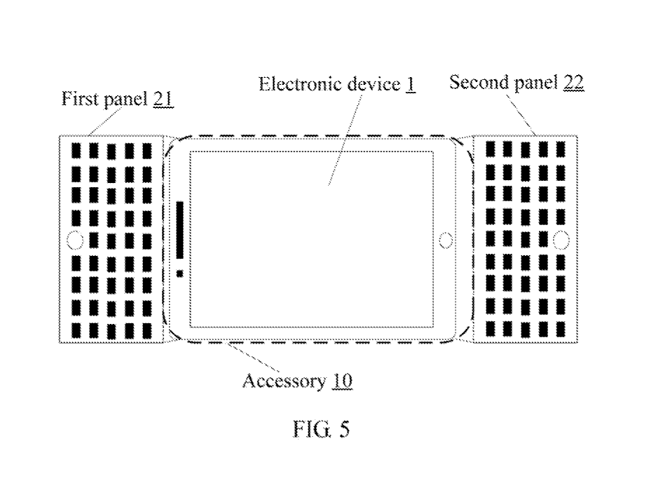

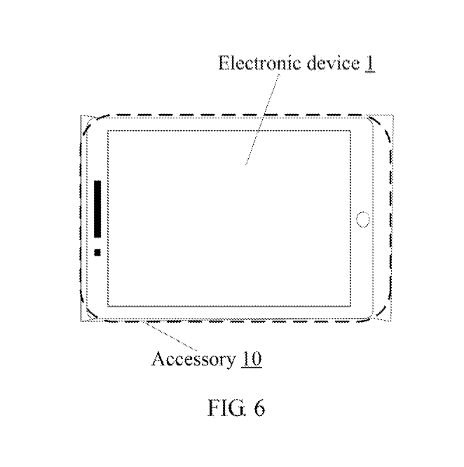

In at least one embodiment, the accessory 10 can be capable of being secured to a back of the electronic device 1, as a protective cover or to provide power for the electronic device 1. In some embodiments, there can be a card slot (not shown) for the fifth panel 25 to enable stable fixing of the accessory 10 on the back of the electronic device 1. In some embodiments, the fourth panel 24 is folded along the creases, and the third panel 23 is turned forward or backward at the same time, to make the third panel 23, the sixth panel 26 and the fourth panel 24 overlap together, as shown in FIG. 5. In sequence, the first panel 21 and the second panel 22 can be turned backward to make the first panel 21, the second panel 22 and the third panel 23 overlap together, as shown in FIG. 6.

In at least one embodiment, when using the loudspeaker 2, the loudspeaker 2 should be folded to a three-dimensional closed shape. An example figure is provided, as there are a variety of ways to locate and secure the first horn 21 and the second horn 22. The present disclosure is illustrated by way of three examples and not by way of limitation.

In first embodiment, the first horn 21 and the second horn 22 can receive audio data from the electronic device 1. If the connection is wired, an end of the audio cable is inserted into an interface of headphone jack (not shown) of the electronic device 1.

In second embodiment, the first horn 21 and the second horn 22 can be BLUETOOTH headphones with a lithium battery power source. After the BLUETOOTH headphones pair with a BLUETOOTH module (not shown) of electronic device 1, the first horn 21 and the second horn 22 can receive audio data from the electronic device 1.

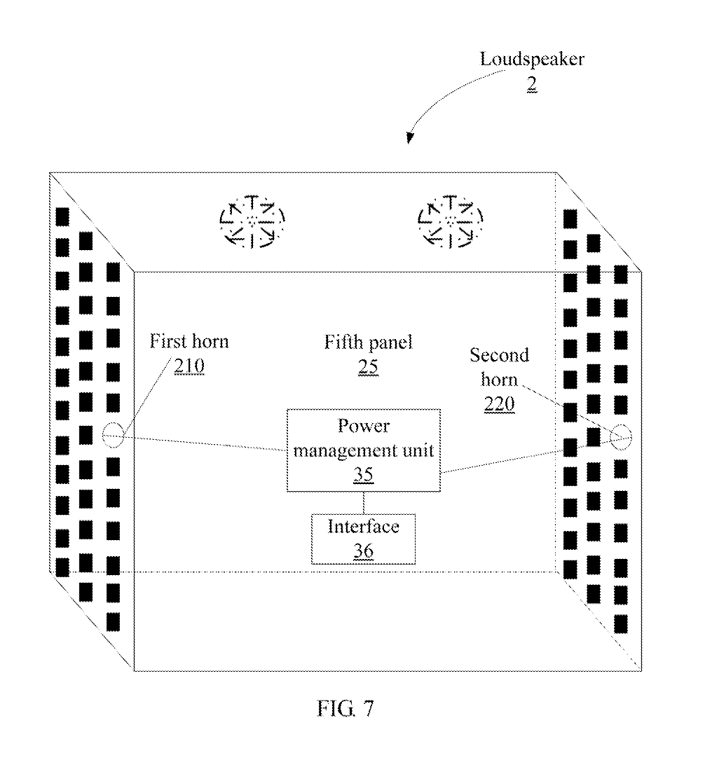

In third embodiment, there can be a power management unit 35 fixed to the inside of the fifth panel 25. In some embodiments, there can be an interface 36 fixed to the outer of fifth panel 25, which is capable of electrically connecting to the power management unit 35, as shown in FIG. 7. The interface 36 can be a Universal Serial Bus (USB) interface, or a mini USB interface. Alternatively, the interface 36 can be a headphone jack. The first horn 21 and the second horn 22 can be capable of electrically connecting to the power management unit 35. In some embodiments, the accessory 10 can directly provide power for the first horn 21 and the second horn 22, through an audio cable connecting the accessory 10 and the interface 36. In some embodiments, the first horn 21 and the second horn 22 can receive audio data from the electronic device 1, through an audio cable connecting the accessory 10 and the interface 36.

It should be emphasized that the above-described embodiments of the present disclosure, and of any particular embodiments, are merely possible examples of implementations, set forth for a clear understanding of the principles of the disclosure. Many variations and modifications can be made to the above-described embodiment(s) of the disclosure without departing substantially from the spirit and principles of the disclosure. All such modifications and variations are intended to be included within the scope of this disclosure and protected by the following claims.

What is claimed is:

1. A loudspeaker, which is capable of fixing to an accessory of an electronic device, the loudspeaker comprising:
a first panel;
a second panel;
a third panel;
a fourth panel;
a fifth panel;
a sixth panel;
a first horn attached on the inner side of the first panel; and
a second horn attached on the inner side of the second panel; wherein the first panel, the second panel, the third panel, the fourth panel, the fifth panel, and the sixth panel are each made of paper material and portray graphics in virtual three-dimensional.

2. The loudspeaker according to claim 1, further comprises a first array of holes distributed evenly on the surface of the first panel; and a second array of holes distributed evenly on the surface of the second panel.

3. The loudspeaker according to claim 2, wherein the sixth panel is seamlessly integrated with the first panel, the second panel, the third panel and the fourth panel; the fourth panel is seamlessly integrated with the fifth panel; the first panel and the second panel are removable and connected to the third panel and the fourth panel respectively.

4. The loudspeaker according to claim 3, a first hook being fixed on an outer edge of the third panel extends out of the left of the third panel; and a second hook being fixed on another outer edge of the third panel extends out of the right of the third panel.

5. The loudspeaker according to claim 3, there are at least one crease on the fourth panel, and folding the fourth panel along with the creases makes the fifth panel and the sixth panel overlap together.

6. The loudspeaker according to claim 5, wherein the fifth panel is enable stable fixing of the accessory.

7. The loudspeaker according to claim 6, wherein the first horn and the second horn receive audio data from the electronic device, through an audio cable connect to a headphone jack of the electronic device.

8. The loudspeaker according to claim 7, wherein the first horn and the second horn are BLUETOOTH headphones with a lithium battery power source.

9. The loudspeaker according to claim 3, wherein a third hook being fixed on an outer edge of the fifth panel extends out of the left of the fifth panel; and a fourth hook being fixed on another outer edge of the fifth panel extends out of the right of the fifth panel.

10. The loudspeaker according to claim 1, further comprises:
a power management unit fixed to the inside of the fifth panel, which is capable of electrically connecting to the first horn and the second horn and used to directly provide power for the first horn and the second horn; and
an interface fixed to the outer of fifth panel, which is capable of electrically connecting to the power management unit and used to receive audio data from the electronic device.
